(19) United States
(12) Patent Application Publication
(10) Pub. No.: US 2006/0277525 A1
(43) Pub. Date: Dec. 7, 2006

(54) Lexical, grammatical, and semantic inference mechanisms

(75) Inventors: Cyrus Najmabadi, Seattle, WA (US); Anson M. Horton, Sammamish, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/147,082

(22) Filed: Jun. 6, 2005

(51) Int. Cl. G06F 9/44

(52) U.S. Cl. 717/106

(57) ABSTRACT

A mechanism is provided for inferring a computer user's intent in developing computer system code. Specifically, an inference mechanism is provided that can infer a user's intent at least on three levels: a lexical level, a syntactic level, and a semantic level. The inference mechanism employs various rule-based and heuristic-based techniques including type coercion, scope proximity, parameter count and arguments, and so on. Various inference mechanism controls are also employed to increase inference robustness, including timing of making suggestions, the number of suggestions, and the extensibility of suggestions.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2005, Microsoft Corp.

### TECHNICAL FIELD

The present aspects generally relate to the field of computing. More specifically, they relate to lexical, grammatical, and semantic inference mechanisms.

### BACKGROUND

Computer users may know what they intend or want to express, but sometimes their intentions are not clearly communicated to a computer system, either because such users make mistakes or don't fully appreciate what they want to express. For example, in the case of developers writing computer code, namely, source code, the intended coding of source code, on the one hand, and what actually gets coded, on the other, may differ vastly. This may occur because the developer mistyped some terms and in fact intended different terms, or because the developer didn't fully realize what terms should have been provided in the source code in the first place.

Upon coding some program, developers may want to compile it (turning source code into object code), but if there are any lexical, grammatical, or semantic mistakes, the program will not compile and the developers may spend an inordinate amount of time correcting the mistakes until they are able to compile the program. Thus, these lexical, grammatical, or semantic mistakes must be addressed even before such a program becomes compilable and therefore subject to debugging.

Also, depending on the type of developer that is coding the source code, one developer may want to fix his mistakes as he is coding, while another developer may want to correct her mistakes at the end of the coding process, once the general program flow and ideas have been set in place. Any feedback regarding such mistakes should be able to accommodate different developing styles, whether by offering suggestions up front as a developer is coding or corrections at the end of the coding process that fix any mistakes. In either case, inferences have to be made as to what a developer meant as opposed to what got actually coded.

In short, inferences about developer mistakes have to be made in order for computer code to be compilable. These inferences are varied and complex and depend on a variety of factors, such as the context of the code. Such inferences may be made on a “word” level, a “grammatical” level, a “meaning” or “semantic” level, a pedagogical level (where the developer has to learn what the proper code is, as in the example of the wrong type being used), developer style level (where either suggestions or fixes are made), and so on. A variety of such inferences have to be made, and these are merely a handful of them.

### SUMMARY

In one aspect taught herein, a user's intent is inferred in interacting with a computing system, for example, in developing a computer code. First, at least one token of the computer code developed by the user is obtained. Then, an inference mechanism is used, where the inference mechanism examines such a token to find out if a mistake has been made by the user in developing that token. The mistake is determined by examining a combination of lexical and syntactic code rules, and a semantic heuristics. Upon identifying any such mistakes, a suggestion and correction are provided in order to remedy the mistake, where the inference mechanism provides the at least one suggestion or correction according to a predetermined standard.

For instance, examining the combination of the syntactic code rules and the semantic heuristics can entail the comparing of scope proximity of a token to at least another token in the code, comparing variable types in the code, examining the number of parameters and arguments in functions and function calls, respectively. Furthermore, examining the aforementioned combination can be based on feedback of how the user is developing the code and how the user has classified private and public accessibility of the code. Lastly, the inference mechanism itself is extensible so that additional syntactic code rules (and lexical rules, for that matter) and semantic heuristics can be added to the existing code rules and heuristics in order to improve inferring the user's intent.

Furthermore, lexical and syntactic code rules can be automatically gleaned from a formal specification for a language that specifies exactly what the correct rules are. Interestingly, the semantic heuristics can also be gleaned from such a formal specification, although they may also be supplemented by manually encoded input.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The foregoing Summary, as well as the following Detailed Description, is better understood when read in conjunction with the appended drawings. The following figures are included:

FIG. 1 illustrates the use of an inference mechanism that is capable of examining computer code on at least three levels in order to determine what a computing system user intended to convey;

FIG. 2 illustrates that once an error or mistake is identified, a correction can either be suggested by an inference mechanism or it can be first corrected by the inference mechanism;

FIG. 3 illustrates various statement completion mechanisms that may be provided by an inference mechanism;

FIG. 4 illustrates type coercion, where one type of variable can be coerced into another type of variable;

FIG. 5 illustrates what happens if a user introduces a statement into the code that does not make sense or is inappropriate, and alternative suggestions are made;

FIG. 6 illustrates the accessibility levels of certain methods that can be exchanged from “public” to “private” and vice versa;

FIG. 7 illustrates that properties of parameters which are most likely to work are suggested as inputs to functions, conditionals, etc.;

FIG. 8 illustrates the use of scope proximity by an inference mechanism in order to figure out a user's intentions;

FIG. 9 illustrates the notion that suggestions are based on feedback in how parameters are used, how methods are called, and so on;

FIG. 10 illustrates a suggestion setting, where the suggestability of an intended parameter, variable, etc. can be invoked based on specified percentage of confidence;

FIGS. 11A, 11B and 11C illustrate how the selection of suggestions is made depending on their relevance;

FIG. 12 illustrates how any heuristics that are provided for an inference mechanism to ascertain mistakes or possible corrections can either come pre-packaged with a compiler or can be extensible to incorporate a user's own heuristics;

FIG. 13 explains the timing of suggestions and corrections;

FIG. 14 explains how a robust completion statement mechanism works;

FIG. 15 illustrates one exemplary implementation of the various aspects discussed in the previous figures; and

FIG. 16 illustrates an exemplary environment where any heuristics employed by an inference mechanism can be employed.

### DETAILED DESCRIPTION

Overview

Various aspects are discussed herein for inferring a computer user's (or more specifically, a developer's) intent in developing computer system code (or any other such code that can be compiled). In particular, an inference mechanism is provided that can infer a user's intent at least on three levels: a lexical level, a grammatical level, and a semantic level. The inference mechanism uses various rule and heuristic techniques illustrated in the figures, including type coercion, scope proximity, parameter count and arguments, and so on. The inference mechanism also has some dynamic heuristics that it derives from the published language specification for a language being analyzed.

Moreover, various inference mechanism controls are also discussed, where these controls are employed to increase inference robustness, including timing of making suggestions, the number of suggestions, and the extensibility of suggestions. Lastly, an exemplary computing environment is provided where the inference mechanism can be used.

Aspects of Lexical, Syntactical and Semantic Inference Mechanisms

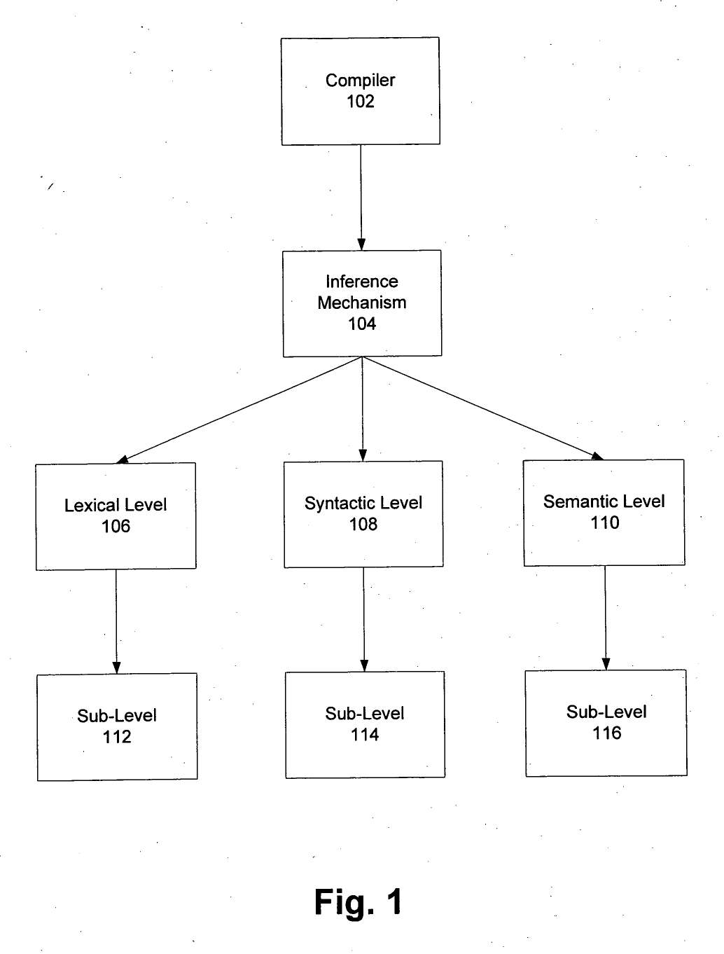

According to FIG. 1, in one aspect, a compiler 102 using an inference mechanism 104 is capable of examining computer code on at least three levels in order to determine what a computing system user (which includes a typical developer) intended to convey when developing the code—when that developer in fact made a mistake or committed an error. It can examine code on (1) a lexical level 106, (2) a grammatical level 108, and (3) a semantic level 110.

At the lexical level 106, tokens are examined, where a token is just any atomic piece of code, such as “int” or “float” or a “if” statement, a variable, or even a scope resolution curly bracket (“{”). Examining the lexical level for a user's intent entails inquiring whether a user might have, for example, inadvertently switched or misspelled tokens. This might happen if a user types “if ( )x” instead of “if(x)”. In such a situation, a user misplaced the “)” bracket and the “x” variable.

The compiler can also examine the grammatical level 108, which includes an inquiry into the proper arrangement of tokens according to computer language rules. The “if( )x” example, discussed above, also happens to be grammatically incorrect, since a parameter like “x” is supposed to be inside the brackets—at least according to high level computer languages like C, C++, C#, etc. There are situations where a variable may be token-wise correct but grammatically incorrect. And then, there may be situations where the two levels overlap, as in the example discussed above.

Furthermore, the compiler can also examine the semantic level 110 to try to ascertain what the user meant based on various heuristics. Such semantic examination of code includes getting at the intention of a user when that intention cannot necessarily be ascertained from the grammatical level 108 mistakes (because there may not be any such mistakes) or from lexical level 106 token misplacement (again, because such mistakes may not be apparent). In such a case, meaning can be gleaned from the way a user has previously developed code and the way the user is using code. All three levels 106, 108, and 110 can also be examined in conjunction in order to obtain a more certain result.

Importantly, within each of the three levels of inquiry considered above, there may be various sub-levels of inquiry particular to any given level. For example, in the lexical level 106 scenario, a compiler can check up to some set number of switching-of-token mistakes 112 but not more than that. Thus, in one aspect, the number of switching-of-token mistakes is set at four. This means that in the “if ( )x” example, up to four switching mistakes could be considered. In this example, two switching mistakes are made: the “)” is switched in the place of “x” and vice versa. But if there is code that requires up to five switches, then it is not considered. The reason for putting a limit on this is because given an unlimited number of switches, any meaningless code would be converted into something meaningful—or something meaningful could be converted into some else that is meaningful and means something different—but was not the intended meaning by the user.

Likewise, the other levels discussed above, namely, the grammatical level 108 and the semantic level 110 can be limited to a set number of sub-levels of inquiry 114 and 116, respectively. Thus, a grammatical error could be limited to the simplest resolution of the error using no more than four computer language rules (per the appropriate language, like C, C++, C#, etc.). And, a semantic error could be limited to the simplest resolution of the error using no more than four intention resolving heuristics. As those skilled in the art will readily appreciate, other code examining levels of inquiry can be employed, and these three levels are merely exemplary, as are their sub-levels of inquiry.

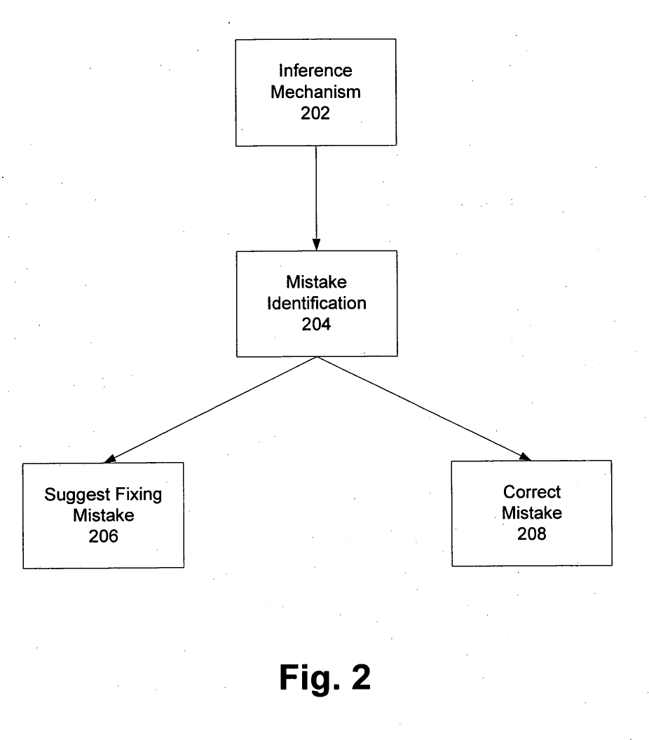

FIG. 2 illustrates that once an error or mistake is identified 204, a correction can either be suggested 206 by an inference mechanism 202 or it can be first corrected 208 by the inference mechanism 202 (and then notice can be given to users that the correction 208 has been made and an opportunity either to accept or reject the correction can be provided). In the discussion below, suggestions 206 are discussed in reference to some figures and corrections 208 are discussed in reference to other figures, but it is understood that all of the below discussion equally applies to both.

Interestingly, the suggestions 206 can be used by the type of developers that like to fix any errors as they are coding, and corrections 208 can be either accepted or rejected by the type of developers that like to code first and fix any errors at the end of the coding process. Moreover, suggestions 206 can be used by the type of developers who want to integrate the inference mechanism 202 into their development practices and depend on it to save them time writing the code manually.

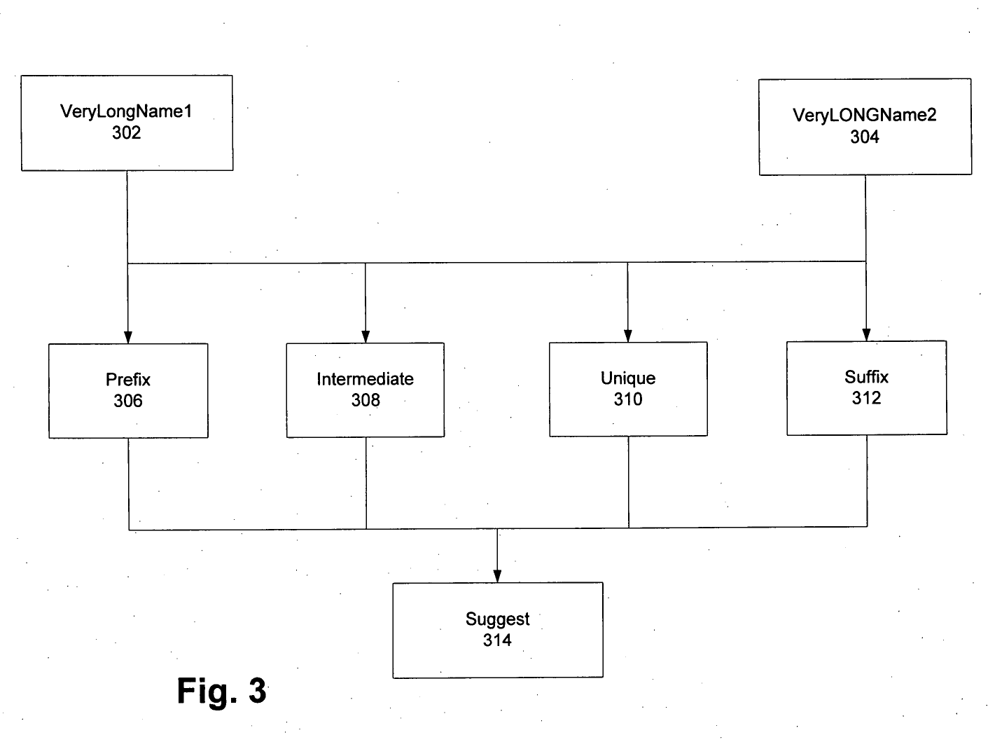

In one aspect, statement completion mechanisms are provided. In reference to FIG. 3, two types of statements may be defined in a program: VeryLongName1 302 and VeryLONGName2 304. Under the prefix statement completion mechanism 306, merely typing the letter “V” will bring up a suggestion 314 of either VerLongName1 302 or VeryLONGName2 304. Then, as the user is typing and gets to the sixth character, typing either a small “o” or a uppercase “O”, VeryLongName1 302 or VeryLONGName2 304 will appear, respectively.

The prefix statement completion mechanism is just one example of statement completion. A suffix statement completion mechanism 312 can also be used. Thus, in FIG. 3, VeryLongName1 302 and VeryLONGName2 304 are determined by merely typing the last letter of each statement. Specifically, if a user types “1” VeryLongName1 302 will be suggested 314 because the last character of VeryLongName1 302 is “1”. Likewise, if “2” is typed, VeryLONGName2 304 is suggested 314 because “2” is the last character of VeryLONGName2 304. Interestingly, this is an example of a user using his or her knowledge of the inference mechanism in order to speed up coding by intentionally writing less code (or intentionally committing what could be characterized as coding errors that the user knows will be fixed by the inference engine) in order to save time. In this case, instead of having to normally type at least six characters (“VeryLo” or “VeryLO”) to get statement completion, the user will only have to type two characters: either the “1” or “2” (as may be the case) and then one character to accept the suggestion offered by the inference mechanism. A savvy developer can suddenly start coding in a form of “shorthand” which the inference mechanism will expend out for him or her. This allows users, especially developers, to focus on the meaning of code while letting the inference mechanism do a lot of the grunt work.

Interestingly, intermediate statement completion mechanisms 308 can be used. Again, given two types of statements that may be defined in a program, namely, VeryLongName1 302 and VeryLONGName2 304, typing in the intermediate character designation of a statement may result in some suggestion 314. In particular, typing in “Long” will suggest 314 VeryLongName1 302, while typing “LONG” will suggest VeryLONGName2 304.

Even more interestingly, unique statement completion mechanisms 310 can also be used. For example, the statement VeryLongName1 302 has several unique characters with respect to any other statement, in this case, VeryLONGName2 304. If a user were to type a small “o” VeryLongName1 302 could be suggested, whereas if the user typed an uppercase “O” VeryLONGName2 304 would be suggested 314. Likewise, there are other characters that makes the two statements unique, some of which include other letters like “N”/“n” or “G”/“g” or numbers like “1”/“2”. Any unique character (whether letter, number, or any other symbol) or name may be used to obtain the desired suggestion 314 that reflects what the user intends or intended to type.

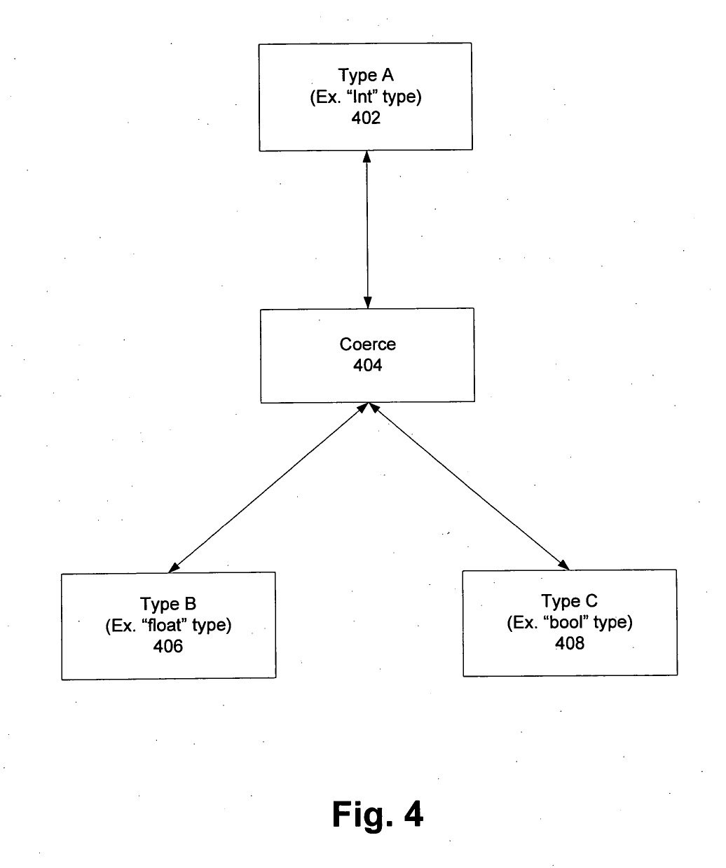

In another aspect, type coercion is performed. FIG. 4 illustrates how one type can be coerced into another type. First, a type A 402 statement is declared. Then, this type of statement, for example, “float” type, can be coerced 404 into another type, Type B 406. This type B 406 statement can be, for example, “int” type. Thus, if a user later on in a program tries to use the “float” type in a function call that only takes “int” types, the “float” type can be coerced or converted into a “int” type.

FIG. 4 illustrates that this type of coercion can occur with other types as well. Thus, an “int” type can be coerced into a “bool” type. For example, if a user writes code that uses a conditional “if” statement, such a statement in programming languages like C sharp takes as its parameter a true or false variable. Thus, if a user mistakenly inserts an “int” in an “if” statement, like the number “5” (e.g. if (5) . . . ), that “int” type can be coerced into a “bool” type (e.g. if (5 !=0) . . . )—which is the appropriate type for an “if” statement. In this case, per FIG. 4, the type B 402 would be coerced into type C 408. Likewise, coercion can be performed both ways—from type C 408 into type B 402.

Furthermore, if a user introduces a variable like “string” type (not illustrated) into the “if” statement, a coercion 404 of the “string” type into “bool” type could be made. By knowing the proper grammar of any given language and examining the semantics of the user's program, a proper type can be introduced so as to avoid confusing a complier and preventing source code from not compiling.

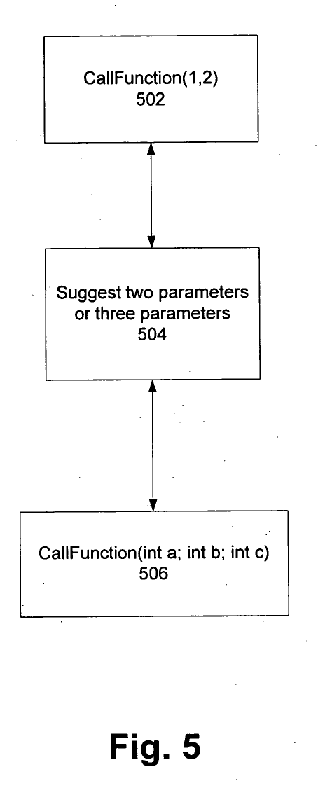

In still another aspect, the grammar and semantics of a user's code could be examined to suggest the correct type and number of statements to use. As FIG. 5 illustrates, if a user introduces a statement into the code that does not make sense or is inappropriate, alternative suggestions can be made. For example, a user may introduce two arguments into a function call, CallFunction(1,2) 502 and yet the function may be expecting three parameters, CallFunction(int a; int b; int C) 506. A suggestion 504 may be made indicating that the user meant to input three arguments not merely two. The reverse is also true, so that if a user meant to input two arguments instead of three, two arguments will be suggested.

Furthermore, the suggestion of whether to use two arguments (if three arguments are used elsewhere in a program) or three arguments (if two arguments are used elsewhere in the program) could be based on the semantics of a program containing both the function call and the function itself. For example, if there are numerous two argument function calls it might be suggestive that three input parameters in the function itself is incorrect. Alternatively, if one function call has two arguments and the rest have three arguments, and the function itself is expecting three parameters, based on these semantics, it could be inferred that the function call should be changed to contain three arguments.

Moreover, the suggestion 504 made by an inference mechanism may reference the type of argument to be input. As discussed above with regard to type coercion, if a user inputs two “int” types into a function call, but a function is expecting, for example, one “int” type and a “string” type, then a suggestion can be made that the user change the latter type to a “string” type—or vice versa, depending on the semantics of the code.

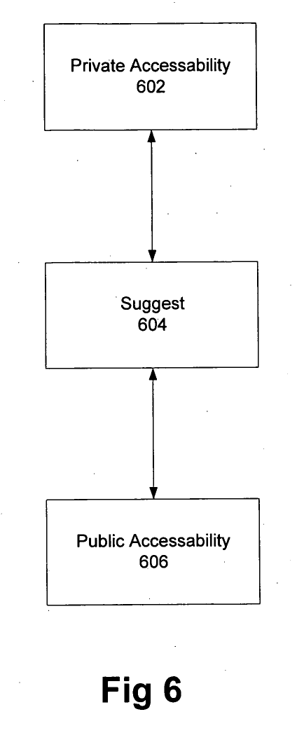

In yet another aspect, in FIG. 6, certain classes may have the accessibility levels of methods set as “private” 602, thus not allowing the use of the methods by certain other code in a program. A suggestion 604 can be made that the class method in question may be recast as “public” 606 instead of “private” 602. Such recasting would allow greater accessibility to methods and other functionalities in the classes in question.

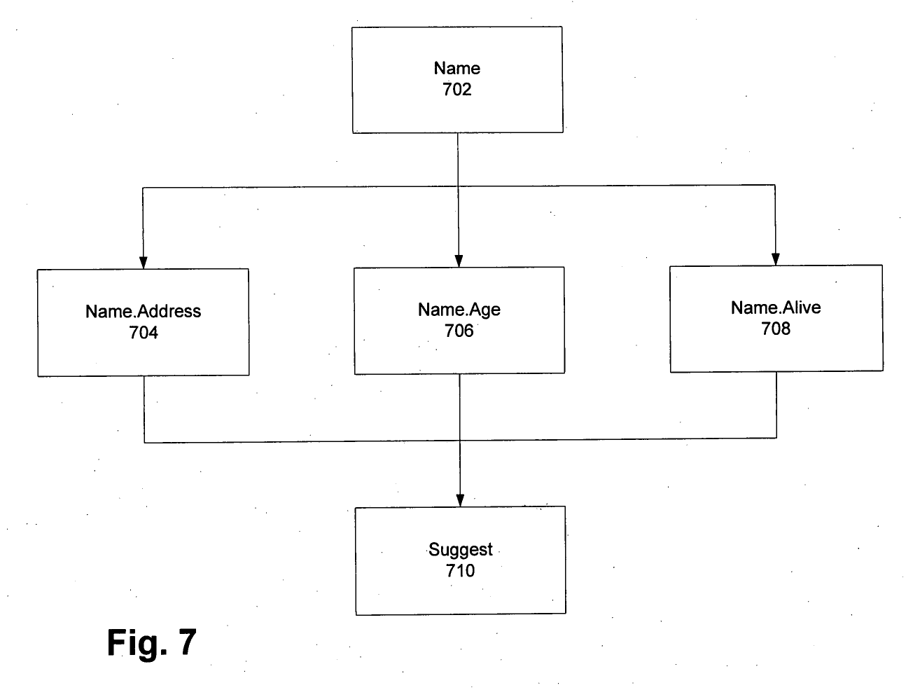

In a further aspect, properties of parameters which are most likely to work are suggested as inputs to functions, conditionals, etc. For example, in FIG. 7, if some parameter like “name” is placed in a conditional “if” statement and this input is not compatible with the statement, an examination is made whether some property of “Name” would be the most likely candidate as input to the conditional statement. Specifically, per FIG. 7, “Name” 702 can have three properties: Name.Address 704, Name.Age 706, and Name.Alive 708. Any of these properties might serve as proper input in some selected context. However, in the context of a conditional “if” statement, for example, only Name.Alive 708 would be proper since this property would have a true or false value that would be appropriate for the conditional statement. Likewise, Name.Address 704 would be the most appropriate for a string input. In short, these exemplary properties of parameters are suggested 710 based on the context in which they are used according to the semantics of the context.

In one aspect, suggestions regarding a possible user mistake are made based on scope proximity. Put another way, if a parameter is typed by a user and it is not recognized by the compiler, suggestions based on relevant parameters that are close in scope are made. The an important insight of the scope proximity aspect is that parameters that are closer in scope are more relevant.

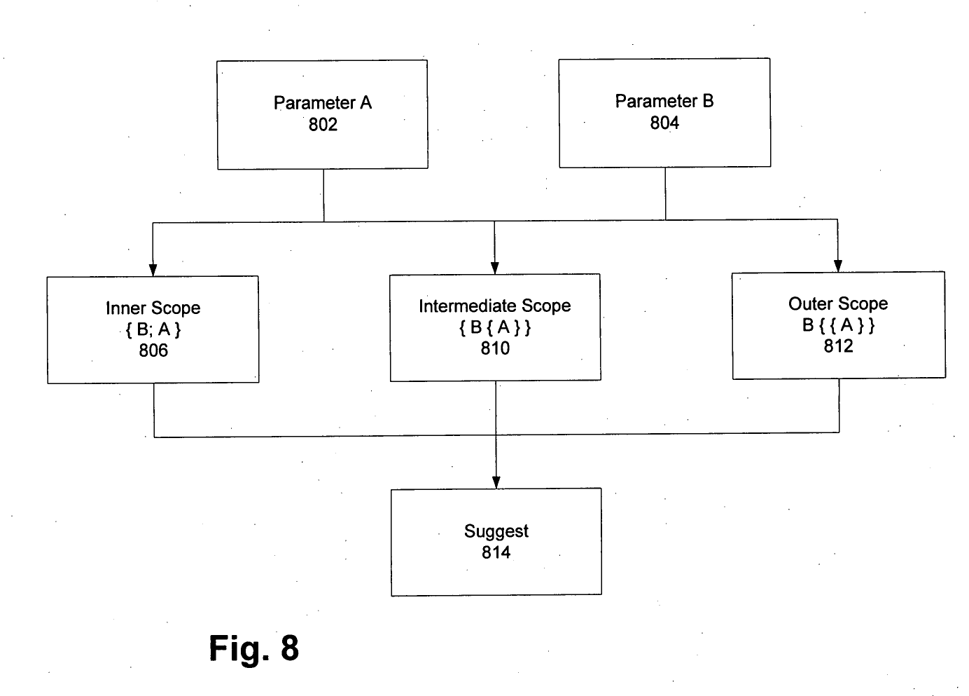

For example, in FIG. 8, parameter A 802 is typed by a user. This parameter may not be recognized for some reason by the compiler. A suggestion 814 can be made as to what the user intended to type based on how close in scope parameter A 802 is to another parameter, say, parameter B 804. If the parameter A 802 has the same scope resolution 806 as parameter B 804, then if the user types parameter A 802 a suggestion 814 may be made that parameter B 804 is relevant. On the other hand, if parameter A 802 is significantly out of scope with parameter B 804, such that parameter B 804 is considered on the outer scope 812 of parameter A 802, then parameter B 804 will be a lot less relevant. It is worthy to note that curly brackets are illustrated here to stand for the notion of scope resolution, however, the notion of scope resolution is not intended to be so limited and it is actually much broader, since parameters in other libraries or imported references can also be considered as being within some scope of another parameter.

Referring again to FIG. 8, if parameter B 804 is within intermediate scope 810 to parameter A 802 (intermediate scope 810 is relative to the inner scope 806 scenario and outer scope scenario 812 discussed above), it will be less relevant then it otherwise would have been had it been within the same curly brackets. Likewise, if parameter B 804 is only within outer scope relative to parameter A 802, then it will be considered even less relevant to the suggestion 814 that what the user meant to type was parameter B 814.

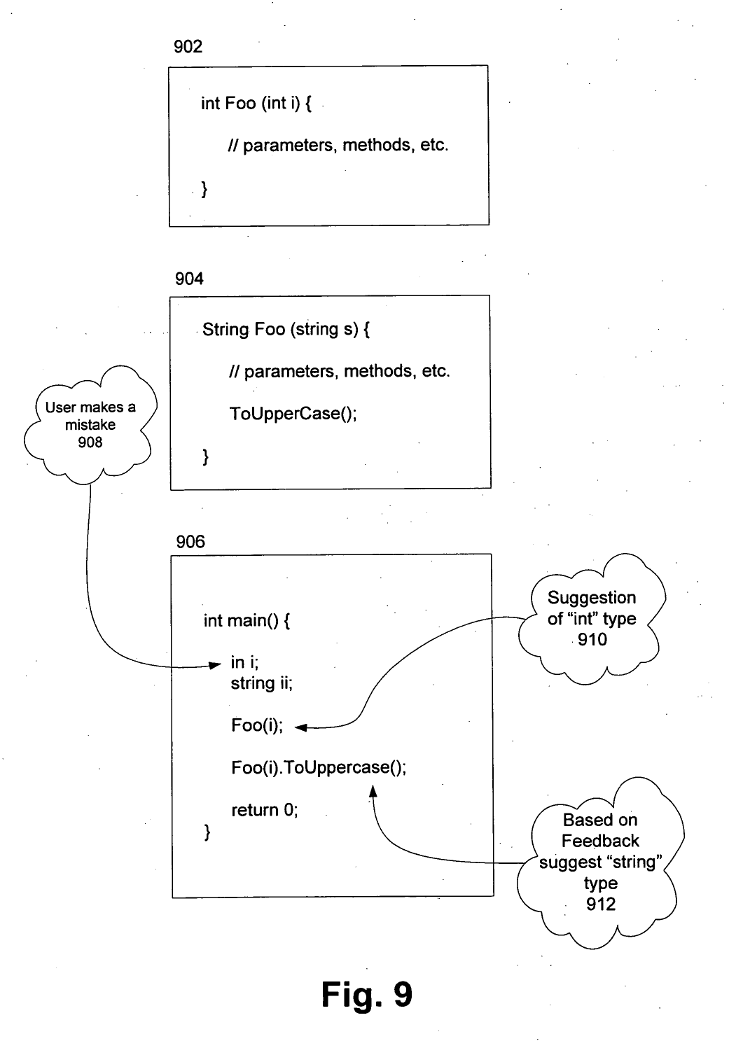

In yet another aspect, suggestions are based on feedback in how parameters are used, how methods are called, and so on. For example, in FIG. 9, sample code is shown with three functions: int Foo(int i) 902; string Foo(string s) 904; and void main( ) 906. In the void main( ) function 906, a user makes a mistake 908 and types “in” instead of “int”, thereby not properly instantiating the variable “i”. But in the function call Foo(i) located in void main( ) 906, the user appears to be calling int Foo(int i) 902, therefore it can be inferred that user meant to declare “int i” rather than “in i”.

However, even though “i” was meant to be declared as an “int” type of variable, in the next line in void main( ) 906, function call Foo(i).ToUppercase( ) is made. Since it does not make sense to call “ToUpperCase” on an “int”—rather that's a proper call on a string type—the user must have meant to type “ii” in the Foo(i).ToUppercase( ) function call. FIG. 9 shows how the determination of one variable (“i” is an “int” type) can have an impact on another variable (“i” cannot be passed to string Foo(string s) and then to ToUppercase( ), therefore “ii” must be the proper variable). Put another way, suggestions as to what a user meant can be based on the feedback 912 provided by one variable (“i”) to another (“ii”). The counterfactual situation is that had “i” been determined to be a “string” type, then the “i” variable in Foo(i).ToUppercase( ) would never have been changed to “ii”.

Furthermore, the proper intended use of a variable can be gleaned from function calls. If some function takes in parameters of one type, but the passed in variable to a function is of another type, an inference case be made that the passed in variable is of the wrong type and should be corrected.

Another important aspect of the inference mechanism is that when the mechanism has a suggestion to make in order to fix a mistake, it will attempt to see how “good” that suggestion is. One way it does this is by pretending the user typed the suggestion in rather than what they've actually typed. The mechanism can then see how many errors/problems are caused when using such a “suggestion”. So, for example, in the Foo(i).ToUpperCase( ) case the inference mechanism sees that “Foo(i)” is a problem. The variable “i” is of type “in” which isn't valid for the “Foo(int)” or “Foo(string)” functions. So two suggestions are proposed internally: “rename ‘in’ to ‘int’” or “replace ‘i’ with ‘ii’”. After determining this initial set of suggestions, the inference mechanism feeds both suggestions back into the code to see which is better. Renaming “in” to “int” helps a little, but then a later problem occurs since you cannot call ToUpperCase on an “int” (i.e. Foo(i).ToUpperCase( ) will be an error even if “i” is an “int”), whereas the change of ‘i’ to ‘ii’ is seen as the better choice because “Foo(ii).ToUpperCase( )” is completely valid code.

Furthermore, inference determination can be performed on a multi-level basis. For example, Foo(i).ToUperCase( ) could be called, where the “Upper” is misspelled as “Uper”. Now, the inference engine will perform multilevel inference with feedback in order to determine the best possible suggestion-taking into account the lexical propriety of “Uper” and the syntactic propriety of passing an “in” to a string function Foo(string). In short, the constantly feedback of an inference back into itself until a suggestion is found that has stayed “alive” the longest (or which has produced the largest amount of correct code) is yet another aspect the inference mechanism implements.

Aspects of Inference Mechanism Control

The inference mechanisms discussed above can be subject to a variety of controls or predetermined standards. For example, the confidence level of a suggestion or correction can be set to some default setting, as can the number of suggestions and correction presented to a user, and the time interval between a user action and a suggestion. These are merely exemplary control standards and are not meant to be limiting or exhaustive.

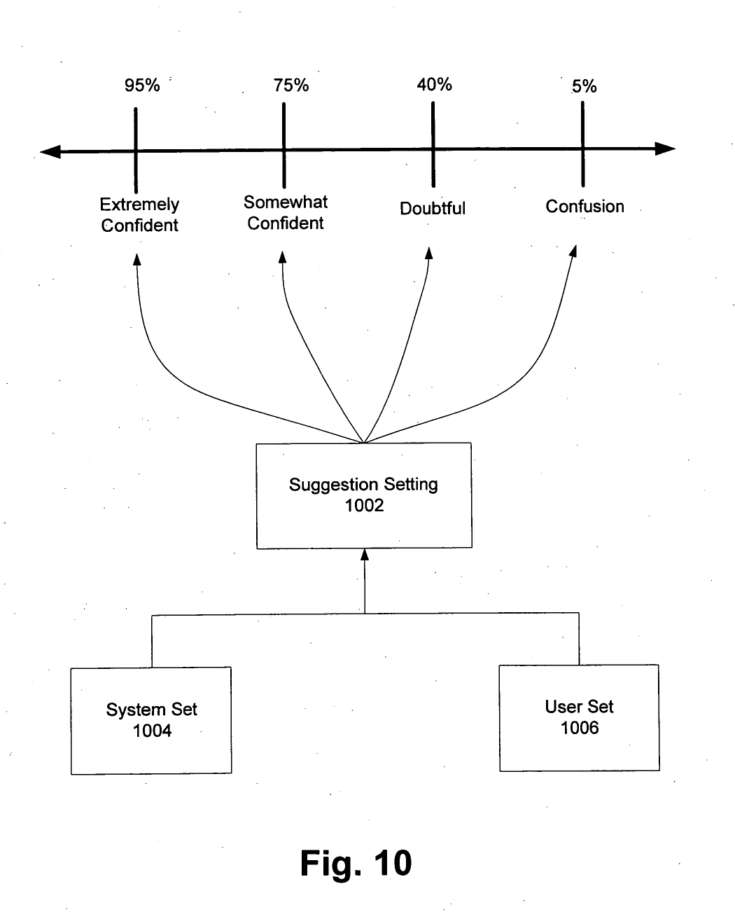

In another aspect, the confidence level of a suggestion can be set either by a computing system or by a user, and moreover, it can be set to some desired level. FIG. 10 illustrates a suggestion setting 1002, where the suggestability of an intended parameter, variable, etc. can be invoked based on specified percentage of confidence. Thus, for example, if there is a 95% confidence that a user intended to type a certain parameter (say, the user typed “Mame” but there is another parameter “Name” defined in the source code), a suggestion can be made to the user that he meant to type what is suggested and not what the user actually typed.

A user may also set a certain cut-off point where suggestions are not to be made below a certain confidence level. For example, in reference to FIG. 10, if there is at least 75% confidence of the user's intention, a suggestion will be presented to the user. But anything below that level, say, a 40% confidence when there is doubt of the user's intent or there is confusion (say, a mere 5% confidence regarding the user's intent), a suggestion would not be made. The reason a suggestion might not be made when the confidence level is too low is because the possible universe of suggestions could be extremely large and hence meaningless. On the other hand, a user may still want to obtain the best possible suggestions, even if they are based on a low confidence level. Such a user can manipulate the suggestion settings accordingly.

Interestingly enough, not only can the user set 1006 the suggestion settings, but they can also be set by a computing system 1004. Vendors who come up with the numerous inference mechanisms (that may be set by the computing system), have a great deal of experience as to which suggestions work and don't work, and which suggestions are the most useful to a particular audience, such as developers, and which are not useful. However, users can supplement these vendor pre-packaged suggestion with those that suit their own purpose.

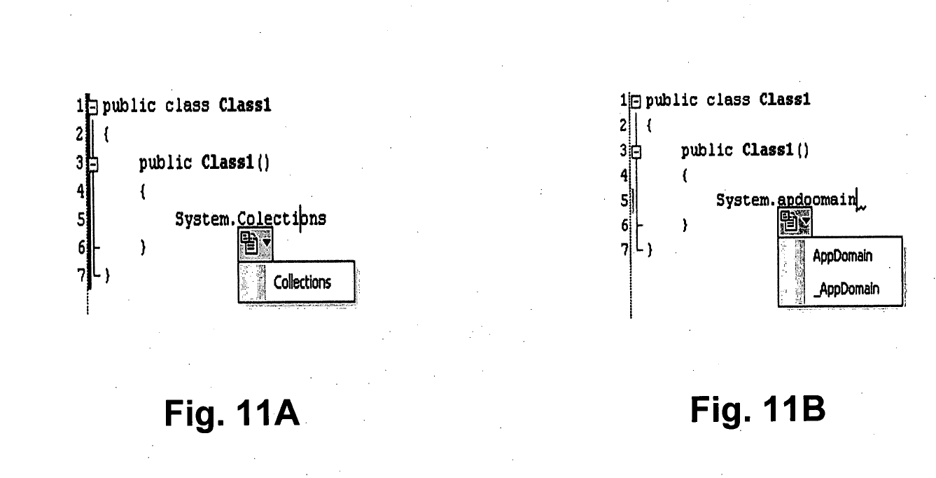

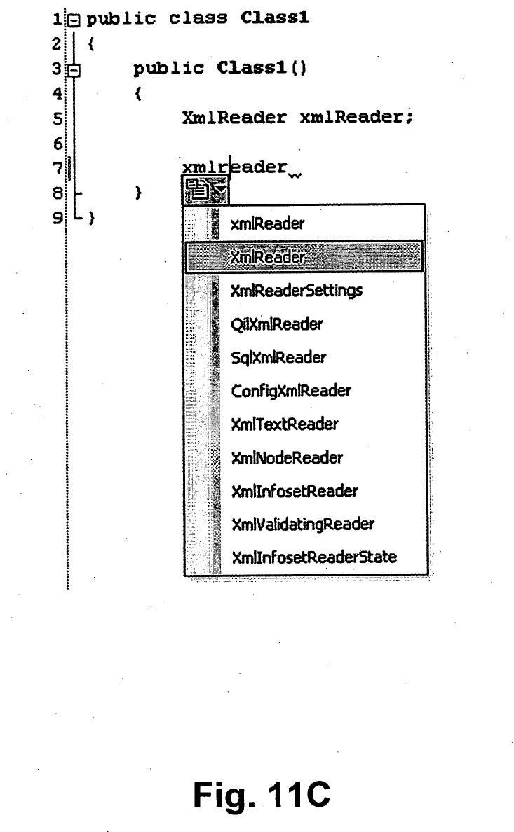

In still another aspect, a select number of suggestions are made depending on how relevant a suggestion is to a mistyped term. FIGS. 11A-11C illustrate typical code which may be typed by a user and suggestions to common spelling mistakes in response to the typed code. Thus, In FIG. 11A a user mistypes “System.Colections” and a suggestion is made that the user meant to invoke the method “Collections” not “Colections”. In FIG. 11B, when the user mistypes “System.apdoomain”, two suggestions are made since two close candidates appear: “AppDomain” and “_AppDomain”. Finally, in FIG. 11C, when the user mistypes “xmlreader” eleven suggestions are made, starting with “xmIReader” and ending with XmlInfosetReader State”. Here, since the term “xmlReader” appears in various contexts (e.g. “ConfigXmlReader”, “XmlNodeReader”, etc.) these various contexts are deemed relevant to the term and presented for selection by the user.

FIGS. 11A-11C illustrate the principle that the number of suggestions is proportional to relevancy of those suggestions to mistyped terms. In FIG. 1I A only one suggestion was made because that was the only relevant suggestion; in FIG. 11B two suggestions were made; and in FIG. 11C eleven suggestions were made. However, in one aspect, as a default, a set number of suggestions can be made—say, five maximum suggestions, because any additional suggestions produce diminishing returns in terms of relevancy.

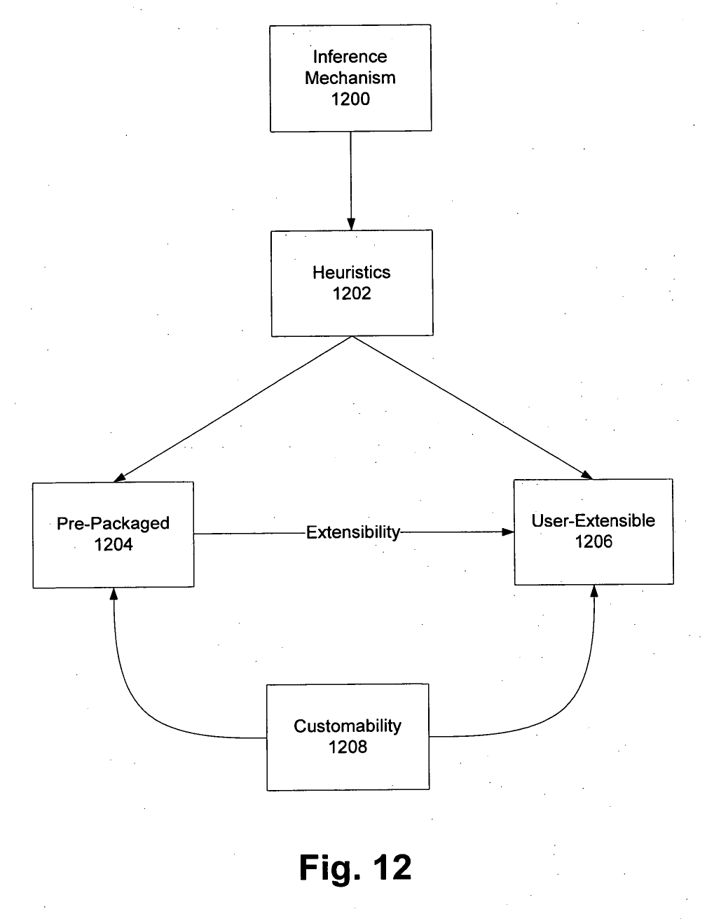

In a further aspect, in FIG. 12, any heuristics 1202 that are provided for an inference mechanism 1200 to ascertain mistakes or possible corrections can either come pre-packaged 1204 with a compiler or can be extensible to incorporate a user's own heuristics 1206. All of the inference mechanisms discussed above, whether applied on the token level, syntactic level, and semantic level, can come pre-packaged 1204 for use by a compiler or may be further or independently developed and extended by computer users 1206. This also means that any user can custom-build 1208 any heuristics based on both what came prepackaged with the compiler and whatever else is available or incidentally developed.

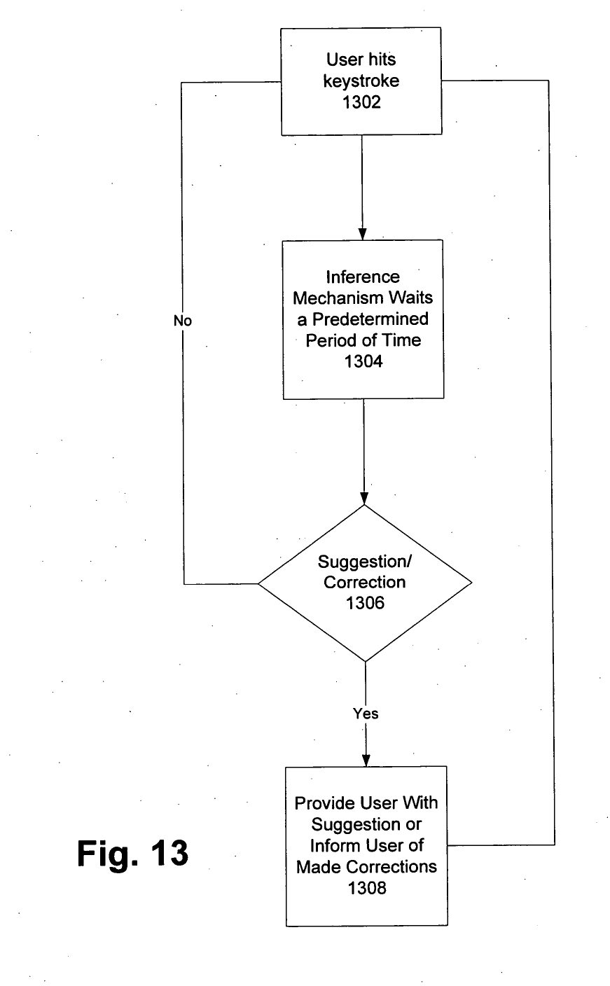

In still a further aspect, FIG. 13 illustrates the timing of suggestions and corrections. At the first block 1302, a user hits a keystroke while at block 1304 the inference mechanism waits for a predetermined period of time. After this period of time, say, 1.5 seconds, at block 1306, either the inference mechanism makes a suggestion (or correction) or it does not. If no suggestion is made, then the inference mechanism simply returns to monitoring keystrokes. However, if a suggestion is to be made, then a user is given choices as to probable inferences of what the user meant to convey.

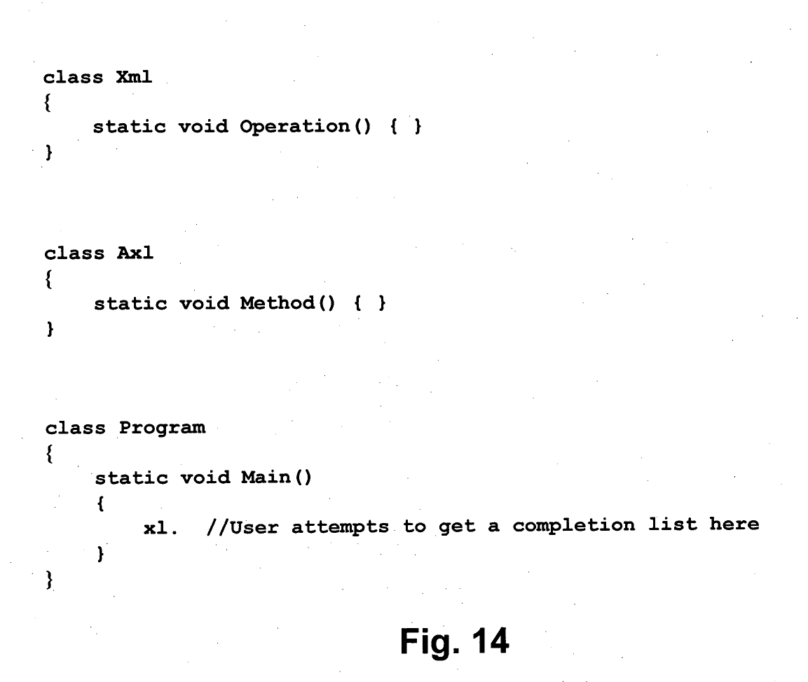

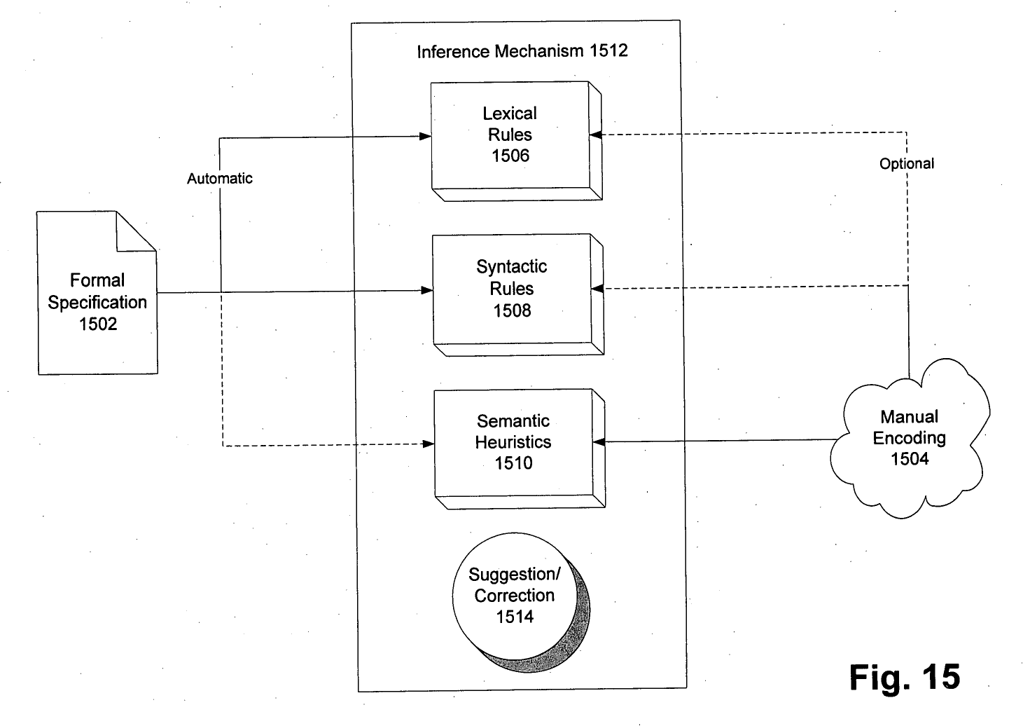

In yet another aspect, one way to present a user with such suggestions is to allow a completion list to pop-up upon the user's hitting a period (“.”). FIG. 14 stands for the idea that even if the user enters a period after the variable “xl”, a completion suggesting “Xml” and “Axl” will pop-up, even though logically nothing follows from “xl”. The inference mechanism is able to infer what the user meant, namely either “Xml” or “Axl”, based on the user merely typing “xl”. This aspect allows for greater error tolerance. Instead of being error intolerant and giving up upon the input of “xl”, in essence, saying that nothing corresponds to “xl”, instead the inference mechanism suggests either “Xml” or “Axi”.

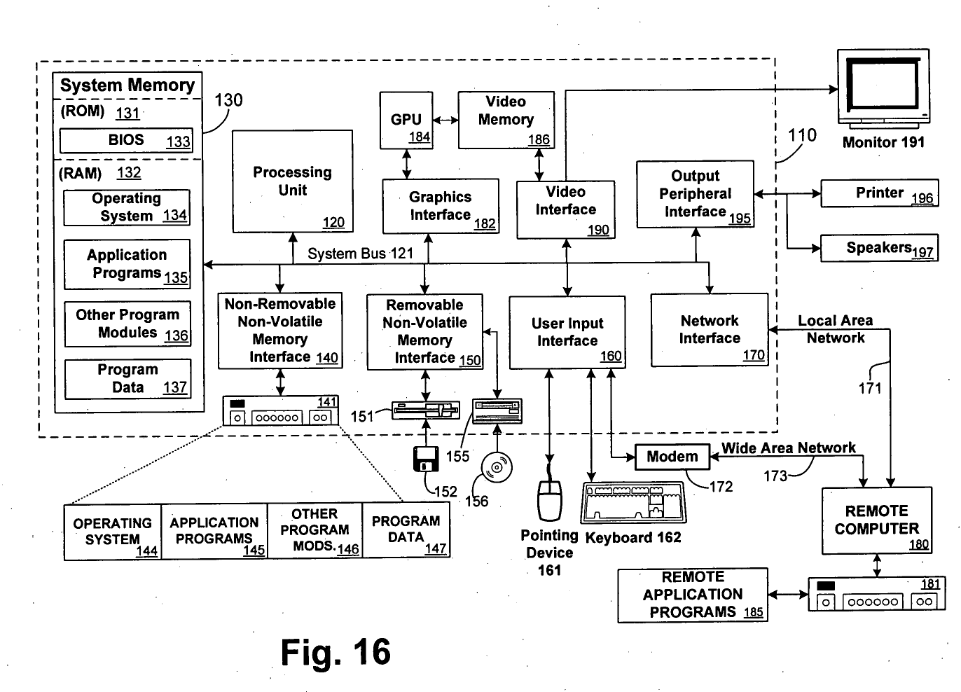

In still another aspect, FIG. 16 illustrates an exemplary implementation of some of the various aspects discussed above. A formal specification 1502 can be the source of the lexical rules 1506 and the syntactic rules 1508. Moreover, the formal specification 1502 can be such a source automatically (shown using the solid line), in contrast to being such a source optionally (shown using the dashed lines). In other words, lexical 1506 and syntactic 1508 code rules can be automatically gleaned from a predetermined formal specification 1502 for a language that specifies exactly what the correct rules are. However, the semantic heuristics 1510 can be gleaned from such a formal specification 1502 optionally. Thus, the semantic heuristics 1510 can be manually encoded 1504 as a matter of course, and optionally, so can the syntactic rules 1508 and the lexical rules 1506. These lexical 1506 and syntactic 1508 rules and semantic heuristics 1510 can make up part of the interference mechanism 1512. Once an inference has been made, a suggestion or correction can be offered 1514.

Exemplary Computing Environment for Token Semantic and Syntactical Inferences

Token, semantic and syntactical inferences are useful in a variety of computing environments. For example, they could be used in coding for printers, applications, or even the central processing units. Use of such inferences reduces the cost to correct errors that inherently entails any kind of coding project while at the same time increases the efficiency of users of such inferences.

FIG. 16 and the following discussion are intended to provide a brief general description of a suitable computing device in connection with which the various aspects discussed above. For example, any of the client and server computers or devices illustrated in FIG. 16 may take this form. It should be understood, however, that handheld, portable and other computing devices and computing objects of all kinds are contemplated for use in connection with the present aspects, i.e., anywhere from which data may be generated, processed, received and/or transmitted in a computing environment. While a general purpose computer is described below, this is but one example, and the present aspects may be implemented with a thin client having network/bus interoperability and interaction. Thus, the present aspects may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved or transmitted to another computer is a desirable, or suitable, environment for operation of the object persistence methods of the aspects.

Although not required, the above discussed aspects can be implemented via an operating system, for use by a developer of services for a device or object, and/or included within application or server software that operates in accordance with the various aforementioned aspects. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, the aspects may be practiced with other computer system configurations and protocols. Other well known computing systems, environments, and/or configurations that may be suitable for use with the aspects include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like.

FIG. 16 thus illustrates an example of a suitable computing system environment in which the various aspects may be implemented, although as made clear above, the computing system environment is only one example of a suitable computing environment and is not intended to suggest any limitation as to the scope of use or functionality of the discussed aspects. Neither should the computing environment be interpreted as having any dependency or requirement relating to any one or combination of components illustrated in the exemplary operating environment.

With reference to FIG. 16, an exemplary system for implementing the aspects includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 16 illustrates operating system 134, application programs 135, other program modules 136, and program data 137.

The computer 110 may also include other removable/non-removable, volatile/nonvolatile computer storage media. By way of example only, FIG. 16 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 16 provide storage of computer readable instructions, data structures, program modules and other data for the computer 110. In FIG. 16, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 16. The logical connections depicted in FIG. 16 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 16 illustrates remote application programs 185 as residing on memory device 181. It will be appreciated that the network connections shown are exemplary and other means of establishing a communications link between the computers may be used.

While the present aspects have been described in connection with the preferred aspects, as illustrated in the various figures, it is understood that other similar aspects may be used or modifications and additions may be made to the described aspects for performing the same function of the present aspects without deviating therefrom. For example, in one aspect, lexical, syntactical and semantic inferences were provided that gleaned a user's intended computer use. However, other equivalent aspects to these described are also contemplated by the teachings herein. Therefore, the present aspects should not be limited to any single aspect, but rather construed in breadth and scope in accordance with the appended claims.

What is claimed:

1. A method for inferring a user's intent in developing a computer code, comprising:
obtaining at least one token of the computer code developed by the user;
using an inference mechanism, wherein the inference mechanism examines the at least one token of the computer code to find out if a mistake has been made by the user in developing the at least one token, wherein the mistake is determined by examining at least one of a lexical rule and a syntactic rule, and at least one of a semantic heuristic; and
providing at least one of a suggestion and a correction to remedy the mistake, wherein the inference mechanism provides the at least one suggestion and correction according to a control standard.

2. The method according to claim 1, wherein examining the at least one of the lexical rule and the syntactic rule, and the at least one of the semantic heuristic includes comparing the scope proximity of the at least one token to at least another token in the code.

3. The method according to claim 1, wherein examining the at least one of the lexical rule and the syntactic rule, and the at least one of the semantic heuristic includes comparing variable types in the code.

4. The method according to claim 1, wherein examining the at least one of the lexical rule and the syntactic rule, and the at least one of the semantic heuristic includes examining the number of parameters and arguments in functions and function calls, respectively.

5. The method according to claim 1, wherein examining the at least one of the lexical rule and the syntactic rule, and the at least one of the semantic heuristic is based on feedback of how the user is developing the code.

6. The method according to claim 1, wherein providing the at least one of the suggestion and the correction to remedy the mistake is based on a percentage of confidence that the inference mechanism is correct.

7. The method according to claim 1, wherein the inference mechanism is extensible so that additional lexical and syntactic rules and semantic heuristics can be added to the at least one lexical and syntactic rules and the at least one semantic heuristic in order to improve inferring the user's intent.

8. A computer readable medium bearing computer readable instruction for inferring a user's intent in developing a computer code, comprising:
receiving a plurality of tokens of the computer code developed by a developer;
subjecting the plurality of tokens to an inference mechanism, wherein the inference mechanism examines the plurality of tokens to find out if an error has been committed by the developer in developing the tokens, wherein the error is determined by examining one of a lexical rule and a syntactic rule, and one of a semantic heuristic; and
providing at least one of a suggestion and a correction to remedy the error, wherein the inference mechanism provides the at least one suggestion and correction according to a predetermined standard.

9. The computer readable medium according to claim 8, wherein examining one of the lexical rule and the syntactic rule, and the semantic heuristic includes comparing the scope proximity of at least one token in the plurality of tokens to at least one other token in the plurality of tokens.

10. The computer readable medium according to claim 8, wherein examining one of the lexical rule and the syntactic rule, and the semantic heuristic includes comparing variable types in the code.

11. The computer readable medium according to claim 8, wherein examining one of the lexical rule and the syntactic rule, and the semantic heuristic includes examining the number of parameters and arguments in functions and function calls, respectively.

12. The computer readable medium according to claim 8, wherein examining one of the lexical rule and the syntactic rule, and the semantic heuristic is based on feedback of how the developer is developing the code.

13. The computer readable medium according to claim 8, wherein providing at least one of the suggestion and the correction to remedy the error is based on a percentage of confidence that the inference mechanism is correct.

14. The computer readable medium according to claim 8, wherein the inference mechanism is extensible so that additional lexical and syntactic rules and semantic heuristics can be added to the inference mechanism.

15. An apparatus for inferring a user's actions in developing a computer code, comprising:
an inference mechanism, wherein the inference mechanism examines token by token any input of tokens in order to determine any mistakes by the user in developing the tokens, wherein any mistakes are determined according to predetermined rules and encoded heuristics, and wherein the inference mechanism provides one of a suggestion and a correction upon determining of any of the mistakes according to a control standard.

16. The apparatus according to claim 15, wherein examining the predetermined rules and encoded heuristics include comparing the scope proximity of the tokens.

17. The apparatus according to claim 15, wherein examining the predetermined rules and encoded heuristics includes comparing variable types in the code.

18. The apparatus according to claim 15, wherein examining the predetermined rules and encoded heuristics includes examining the number of parameters and arguments in functions and function calls, respectively.

19. The apparatus according to claim 15, wherein examining the predetermined rules and encoded heuristics is based on feedback of how the user is developing the code.

20. The apparatus according to claim 15, wherein the inference mechanism is extensible so that additional predetermined rules and encoded heuristics can be added to the inference mechanism.
